(19) United States
(12) Patent Application Publication
(10) Pub. No.: US 2022/0248180 A1
(43) Pub. Date: Aug. 4, 2022

(54) SELECTIVE SHARING OF DEVICE LOCATION INFORMATION

(71) Applicant: Apple Inc., Cupertino, CA (US)

(72) Inventors: Rajesh Gadipuuri, Mountain View, CA (US); Krishna M. Behara, Santa Clara, CA (US); Manjunath A. Tarikonda, Pleasanton, CA (US); Pranav P. Sawant, Sunnyvale, CA (US)

(73) Assignee: Apple Inc., Cupertino, CA (US)

(21) Appl. No.: 17/589,612

(22) Filed: Jan. 31, 2022

Related U.S. Application Data
(60) Provisional application No. 63/143,848, filed on Jan. 30, 2021.

(51) Int. Cl. H04W 4/029; H04W 12/02

(52) U.S. Cl. CPC H04W 4/029; H04W 12/02

(57) ABSTRACT

Techniques for selective sharing of device location are described. An electronic user device may reference a location index generated by a service provider as part of deciding whether to share its device location. The location index may ensure that the electronic user device shares relevant location information, while refraining from sharing location information of a sensitive or private nature.

### CROSS REFERENCE TO RELATED APPLICATIONS

This application claims priority under 35 U.S.C. § 119(e) to U.S. Provisional Application No. 63/143,848, filed on Jan. 30, 2021. The entire contents of which is herein incorporated by reference.

### BACKGROUND

Many electronic devices have the capability of recording location data responsive to certain actions. For example, when an application is launched, an electronic user device may receive a geographic location (e.g., from an onboard location sensor) of the device when the application was launched. Data surrounding this application launch may be stored on the electronic user device and/or shared with a service provider.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method implemented at an electronic user device. The computer-implemented method also includes receiving location information associated with a current location of the electronic user device. The computer-implemented method also includes determining whether the location information meets at least one criterion of a plurality of location criteria, where a first criterion of the plurality of location criteria includes whether a location index includes a sub-region identifier for a sub-region that includes the current location. The computer-implemented method also includes sending a data payload including the location information to a service provider when the at least one criterion is met. The computer-implemented method also includes refraining from sending the data payload including the location information to the service provider when the at least one criterion is not met. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates a diagram depicting aspects of selective sharing of device location information, according to at least one example.

FIG. 2 illustrates a flowchart of a first portion of a process for selective sharing of device location information, according to at least one example.

FIG. 3 illustrates a second portion of the process from FIG. 2 for selective sharing of device location information, according to at least one example.

FIG. 4 illustrates a flowchart of a process for selective sharing of device location information, according to at least one example.

FIG. 5 illustrates a flowchart of a process for selective sharing of device location information, according to at least one example.

FIG. 6 illustrates an example architecture or environment configured to implement techniques relating to selective sharing of device location information, according to at least one example.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, approaches for electronic user devices to selectively share location data with a service provider in a privacy-protected manner. In a particular example, electronic user devices are configured to share location data e.g., on application launches, only in certain non-residential public places. In this manner, location activities of a user at their home and other sensitive locations may not be shared with the service provider, but similar activities of the user when performed outside of their home, e.g., near grocery stores, pharmacies, and other points of interest may be shared. The activities that are shared with the service provider may be used to enable multiple different services such as, for example, busyness information (e.g., information that describes how busy a certain location is at different times), location popularity (e.g., information that describes how popular a certain location is with respect to other similar locations and/or with respect to different times of the day), location searches, and any other suitable services. The approach for location sharing described herein strikes a balance between sharing all location data, which is overly intrusive of users' private activities, and sharing just enough location data to enable helpful services that benefit the user and other users in the same area.

To enable the approaches described herein, an electronic user device makes location sharing decisions using a set of location criteria. A first criterion depends on a location index. The location index, which may be periodically generated by the service provider and sent to the electronic user device, may be specific to a geographic region in which the electronic user device is located during some recent period of time. For example, each night an electronic user device such as a smartphone will receive a location index from the service provider based on the current location (e.g., a location of the device at 11:00 PM). The location index may represent sub-regions (e.g., a 20 meter by 20 meter cell) within the geographic region (e.g., a 40 kilometer×40 kilometer square) that include points of interest, areas of interest, and the like. For example, for those sub-regions that include specific categories of points of interest, sub-region identifiers may be computed by the service provider and included in the location index. For sub-regions that include non-public areas or prohibited areas, the location index is devoid of a sub-region identifier. In this manner, the location index may be used to determine whether or not a region is one where sharing particular location information with the service provider is allowed or prohibited. In some examples, the location index may include other information relating to the point of interest or area of interest (e.g., a type of point of interest, etc.).

As introduced herein, a location index may represent points of interest in a geographic region that is defined by some perimeter boundary. For example, a geographic region may have a square shape, e.g., 40 kilometers×40 kilometers or take any other shape or form. The area within the boundary may be divided into cells of equal or arbitrary size. For example, continuing with the 40 kilometer×40 kilometer region, this region may be divided into 20 meter×20 meter cells. Of course, larger or smaller geographic regions may be defined including larger and smaller cells. In some examples, larger regions and larger cells may be used in less dense areas (e.g., rural cities), while smaller regions and smaller cells may be used in more dense urban areas. The size determination of geographic regions and divisions within regions may consider the density of points of interest within the more urban areas. Each cell may correspond to a sub-region within the geographic region. The service provider may generate the location index by reading point of interest data from a map data database (e.g., a database of data used to populate a map application on the electronic user device), filtering the point of interest data based on an allowed point of interest categories list (e.g., grocery stores, restaurants, pharmacies, schools, hotels, venues, bars, etc.), and filtering the point of interest data based on regions (e.g., removing regions such as military bases, certain wildlife areas, water features, etc.) to create a list of select points of interest that can be mapped to individual cells in the geographic region. In some examples, the location index may be around 2 mb in size, but in some examples may be larger or smaller.

As described herein, the location index may be sent to the electronic user device based on location (e.g., where the electronic user device is located at a particular time), periodically (e.g., every day, every week, every month, every 12 hours, etc.), and/or dynamically based on location (e.g., if the device location changes beyond some threshold, the device may request an updated location index). The location index may be downloaded to the electronic user device when certain power criteria are met (e.g., plugged in and charging and connected to WiFi). The location index may be cached and deleted if not used within some fixed amount of time (e.g., certain number of seconds, minutes, hours, etc.). In some examples, the electronic user device may download a new location index and compare it to an existing location index. If the two indices are the same, the electronic user device may return and/or delete one of them. In some examples, instead of or in addition to downloading another location index, the electronic user device may receive a representation of some portion of the index such as a hashed key that can be compared against the earlier version to identify any differences. For example, an HTTP Etag may be used to only download a new location index, if that index has changed. Various hashing algorithms (e.g., md5sum check) may also be used to determine whether a new index should be obtained.

As mentioned, the electronic user device makes location sharing decisions using the set of location criteria. In addition to the location index being a criterion, other criteria may be considered when deciding whether or not to send location information to the service provider. For example, a recency criterion (e.g., a threshold number of minutes (e.g., 2-10) has passed since the last successful upload of location information), hour-based success criterion (e.g., a threshold number (e.g., 5-15) of unsuccessful uploads in the last hour), day-based success criterion (e.g., a threshold number (e.g., 20-40) of unsuccessful uploads in the last day), an age criterion (e.g., an age of the location information is less than an age threshold), a location accuracy criterion (e.g., location accuracy of the location information meets or exceeds an accuracy threshold (e.g., 50-120 meters)), a location sent time criterion (e.g., a time between an updated location and the location information is less than a time threshold (e.g., 2-10 minutes)), a location sent distance criterion (e.g., a distance between an updated location and the location information is less than a distance threshold (e.g., 5-20 meters)), and any other suitable criterion. In some examples, uploading the location information may also be based on battery life of the electronic user device, network connectivity, and any other suitable criterion. In some examples, the location information may be uploaded every few minutes. The information included in the location information payload may include, for example, latitude, longitude, number of nearby Bluetooth devices, point of interest identifier, and unique user identifier that is generated at some cadence (e.g., every few hours) and allows to uniquely and anonymously identify users for some limited time period. The payload may optionally include speed, motion activity, point of interest identifier score, and may not include private location information or personally identifying information.

The examples described herein address a number of technical problems and provide a number of technical improvements. In some examples, these improvements additionally improve the functioning of various components of a system in which the techniques are implemented. The techniques described herein provide for selective sharing of device location in a manner that conserves network resources, battery life, and processing resources, as compared to conventional systems. For example, rather than a user device sharing its location information at all times, the electronic user device refrains sharing location information when the electronic user device is outside a threshold distance from a point of interest (e.g., 5 meters, 10 meters, 20 meters, 50 meters, or at any other suitable distance), when the electronic user device is moving at a speed above some threshold (e.g., 4 miles per hours, 5 miles per hour, 10 miles per hour, or at any other suitable speed), and when the electronic user device is located at or adjacent to certain private locations. These actions function to conserve resources of the electronic user device and bandwidth. Not collecting while the electronic user device is moving may have the added benefit of the removal of noise from the data because of exclusion of cars and surrounding traffic. The approaches described herein additionally provide for improved user privacy in location sharing systems, as compared to conventional systems. For example, the location index used by the electronic user device to make location sharing decisions may only include points of interest that have historically seen high enough activity to preserve user anonymity. This may be set by the service provider using a threshold. This ensures that the electronic user device does not share location information for locations that can be easily tied back to the user of the electronic user device.

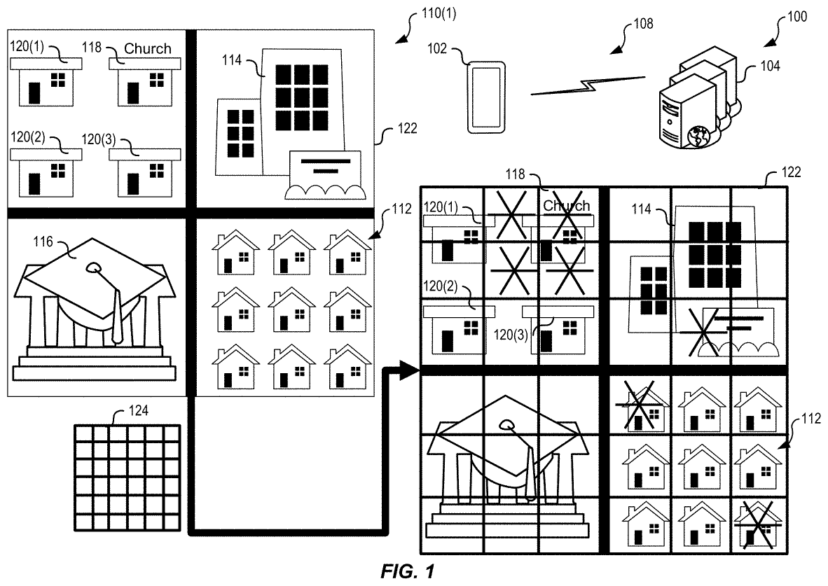

Turning now to the figures, FIG. 1 illustrates a diagram 100 depicting aspects of selective sharing of device location information, according to at least one example. The diagram 100 includes a system 108 that includes an electronic user device 102 and a service provider 104 (e.g., one or more server computers). The electronic user device 102 and the service provider 104 may be in network communication via any suitable network such as, for example, a cellular network, the Internet, a wide area network, and the like. The electronic user device 102 may be configured to collect location information descriptive of a location of the electronic user device 102. Generally, according to the examples described herein, service provider 104 may generate location indices for the electronic user device 102 to use when making decisions about collecting and/or sharing location information about the electronic user device 102 with the service provider 104. In some examples, the electronic user device 102 may download the indices from the service provider 104 when certain conditions are met (e.g., charging and connected to WiFi). In some examples, the service provider 104 may provide an index service that sends location indices to the electronic user device 102 responsive to requests from the electronic user device 102.

Turning now to the details of FIG. 1, the diagram 100 depicts two views 110(1) and 110(2) of an example neighborhood 110 that includes various example types of entities. For example, the neighborhood 110 includes residences 112, an office building 114, a university 116, a place of worship 118, and various merchants 120(1)-120(3). Other entities may also be represented using the techniques described herein.

The neighborhood 110 may be defined as a geographic region having a perimeter boundary 122. The neighborhood 110(1) on the left may have been obtained from a mapping service that maintains geographic data. In addition to types of entities, the geographic data may include data that defines political divisions, private vs. public property, neighborhood divisions, government vs. non-government, property, and the like. In some examples, the service provider 104 may use the geographic data to define the perimeter boundary 122 of the neighborhood 110. The perimeter boundary 122 may be of a standard size or may be specifically configured. Thus, other geographic regions may be defined around the neighborhood 110.

Generally, the service provider 104 may use the geographic information available within the perimeter boundary 122, information about users of electronic user devices in the neighborhood, and sub-region information to generate a location index 124. The service provider 104 may then apply the location index 124 to define which points of interest are associated with which subregions in the neighborhood 110.

To generate the location index 124, the service provider 104 may read point of interest data (e.g., information associated with the entities depicted in the neighborhood 110(1)) from a map data database (e.g., a database of data used to populate a map application on the electronic user device 102), filter the point of interest data based on an allowed point of interest categories list (e.g., information associated with the entities in the neighborhood 110(1) such as grocery stores, restaurants, pharmacies, schools, hotels, venues, bars, etc.), and filter the point of interest data based on regions (e.g., removing regions such as military bases, certain wildlife areas, water features, etc.) to create a list of select points of interest that can be mapped to individual sub-regions (e.g., cells) in the geographic region. Thus, in this example, the location index 124 includes not only a division of the geographic region, but also includes information associated with each sub-region about what geographic feature is included with the sub-region.

Once the location index 124 has been created, the location index 124 may be shared with the electronic user device 102. The electronic user device 102 may maintain information about locations that are private to the user of the electronic user device 102 (e.g., a personal residence, a work location, a place of worship, etc.). As shown in the neighborhood 110(2), sub-regions that include these private locations may be marked by a “star.” This includes, for example, sub-regions that include the place of worship 118, sub-regions that includes two residences 112, and a sub-region that includes a portion of the office building 114. In some examples, the electronic user device 102 alone may maintain information about these locations. Because the service provider 104 does not receive and/or maintain information about private locations, the location index 124 does not identify private locations. Rather, the electronic user device 102 will filter the location index 124 (e.g., when at a specific location in the neighborhood 110) in a manner that eliminates the possibility of the electronic user device 102 sending and/or sharing location information associated with events that occur near these private locations. Thus, the neighborhood 110(2) is a graphical representation of what a map would like if the electronic user device 102 combined the location index 124 with the private location information. This is presented this way for illustrative purposes. If the electronic user device 102 records its location within any of the sub-regions associated with the place of worship 118, the electronic user device 102 will refrain from reporting this location information to the service provider 104. The same goes for the other private locations shown in the neighborhood 110(2). On the other hand, if the electronic user device 102 records its location within any of the other sub-regions that are not prohibited, the electronic user device 102 may sends its location information to the service provider 104, in accordance with the techniques described herein.

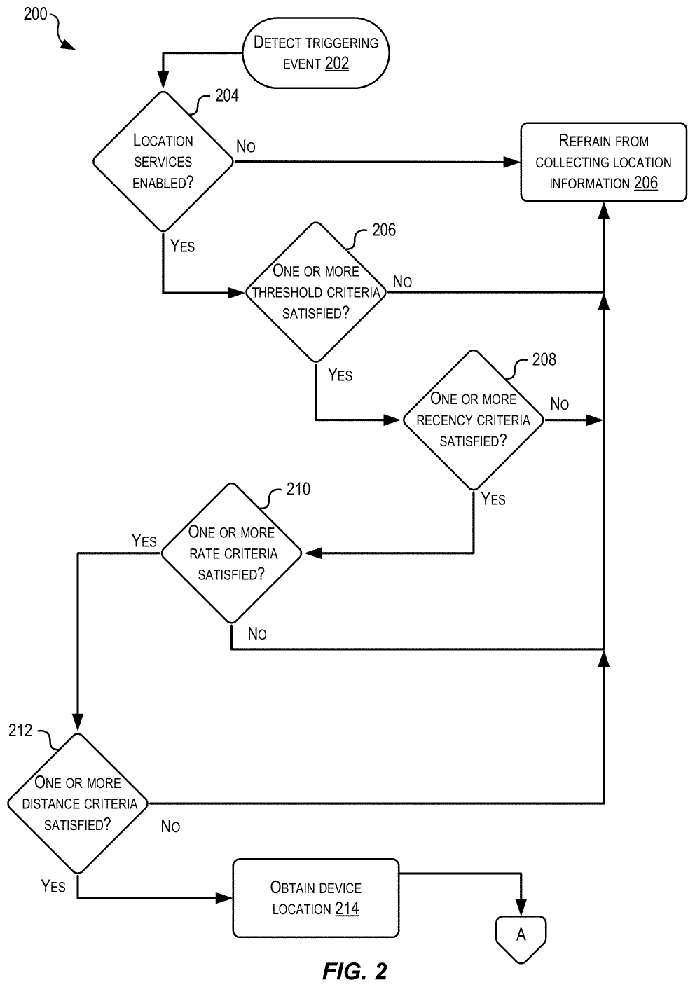

FIGS. 2, 3, 4, and 5 illustrate example flow diagrams showing processes 200, 400, and 500, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer readable storage medium, for example, in the form of a computer program including a plurality of instructions executable by one or more processors.

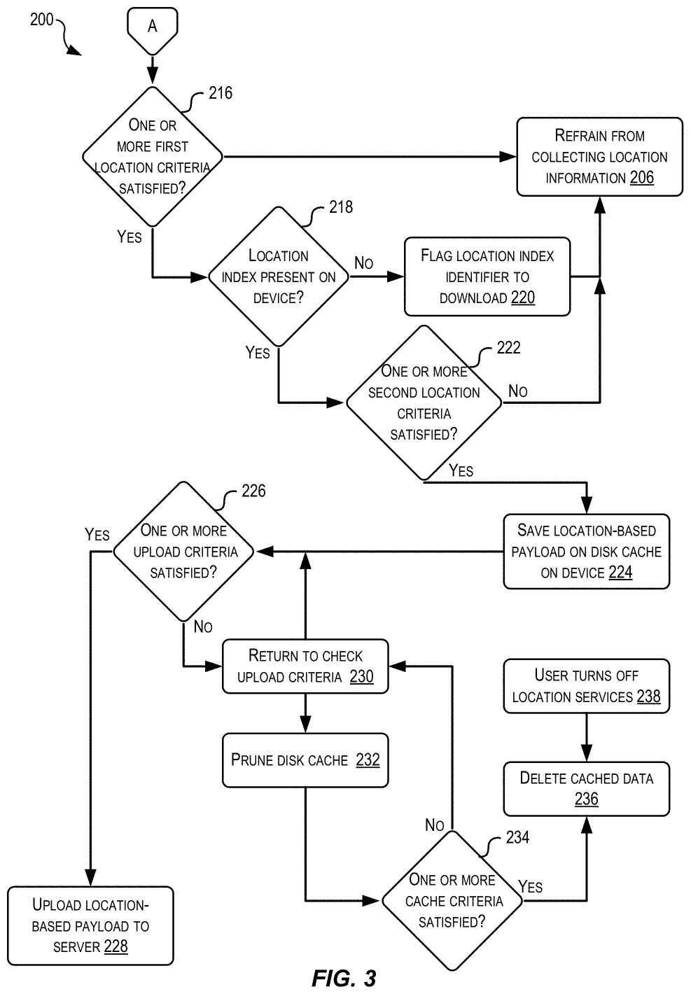

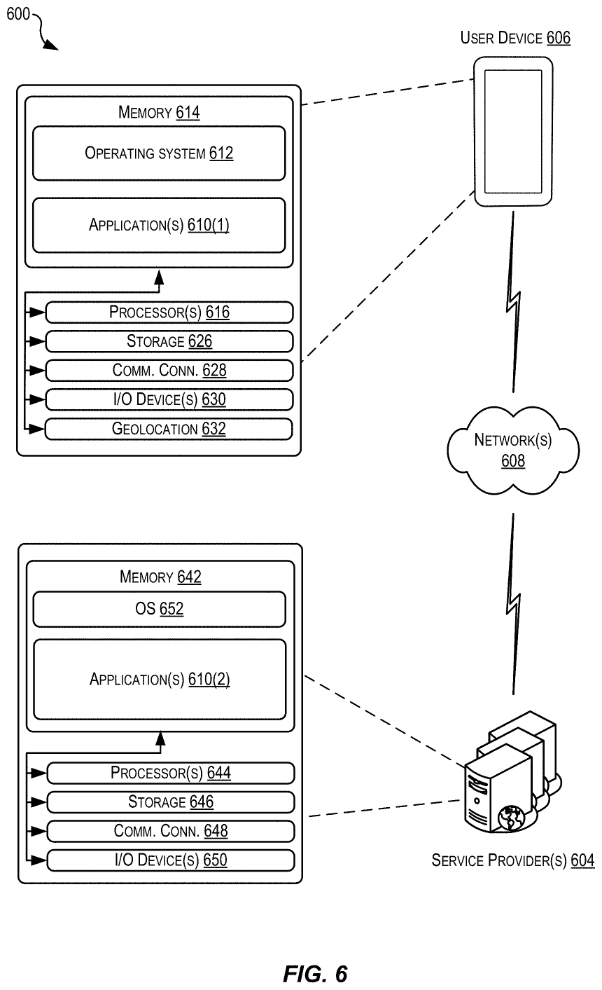

FIGS. 2 and 3 illustrate a flowchart of a process 200 for selective sharing of device location information, according to at least one example. The process 200 may correspond in particular to an essentially end-to-end approach performed at an electronic user device for selectively sharing device location information with a service provider. A sharing application 610 (FIG. 6), whether embodied in an electronic user device 606 (FIG. 6) or a service provider computer 604 (FIG. 6), or any suitable combination of the foregoing may perform the process 200. Thus, while the process 200 is described as being performed by the electronic user device, it should be understood that other user devices (e.g., a wearable user device) or a server may perform the process 200 with limited adjustments.

As shown in FIG. 2, the process 200 begins at block 202 by the electronic user device detecting triggering event. This may include the electronic user device detecting one of a predefined set of activities relating to sharing location information. For example, the electronic user device may evaluate actions of the user on the electronic user device (or background processes) to determine whether the detected user activity is the kind that prompts location collection. In some examples, opening an application on the electronic user device may be a type of user activity that, when detected, triggers the process 200 to begin. In some examples, the triggering event may be based on a timer. For example, the electronic user device may periodically trigger the process 200 after a certain period of time has passed (e.g., 5 minutes, 30 minutes, 1 hour, 5 hours, 12 hours, 20 hours, 24 hours, 48 hours, and any other suitable period of time). The triggering event may also be based on a location of the electronic user device. For example, if the location of the electronic user device changes beyond some threshold or in such a manner that the current location index is no longer relevant, these events may also trigger the process 200.

At block 204, the process 200 includes the electronic user device determining whether location services are enabled on the electronic user device. This may include checking configuration settings on the electronic user device to determine whether the user has authorized collection of device location. In some examples, the user may be prompted to enable location services at this point and/or when the triggering event is detected at block 204.

If the answer at block 204 is no, the process 200 continues to block 206. At block 206, the process 200 includes the electronic user device refraining from collecting location information. Thus, if the user has not enabled location services on the electronic user device, the electronic user device will not collect location information.

If the answer at block 204 is yes, the process 200 continues to block 208. At block 208, the process 200 includes the electronic user device evaluating whether one or more threshold criteria are satisfied. The one or more threshold criteria may include, for example, power criteria (e.g., a state of a low power mode on the electronic user device, a percentage battery available on the electronic user device, and other similar criteria relating to the power of the electronic user device) and a private location criteria (e.g., the current location of the electronic user device is not the same as a private location such as a home, work, place of worship, school, and the like).

In some examples, the private location criteria may be evaluated by collecting a real-time location of the electronic user device and comparing the real-time location to a private location information corresponding to a set of private locations. The private location information may describe the private locations in any suitable manner. For example, the private location information may include a geographic point (e.g., a latitude and longitude) and an associated radius surrounding the geographic point, a geographic area (e.g., a description of a two-dimensional area that corresponds to the private location) that is a radius or takes a different shape, a political or property boundary associated with the private location (e.g., a parcel boundary), and any other suitable definition.

If the answer at block 206 is no, the process 200 continues to block 206. At block 206, the process 200 includes the electronic user device refraining from collecting location information. Thus, if the low power mode has been activated, if the percentage battery is below a threshold (e.g., 25%, 40%, 50%, 75%, and any other suitable percentage), and/or if the electronic user device is located at a private location, the electronic user device may not collect location information.

If the answer at block 206 is yes, the process 200 continues to block 208. At block 208, the process 200 includes the electronic user device evaluating whether one or more recency criteria are satisfied. The one or more recency criteria may consider the timing of a last successful location collection. For example, if the most recent location collection by the electronic user device occurred less than five minutes ago, the answer at block 208 may be no, meaning the electronic user device already reported an accurate location and therefore does not need to collect again.

If the answer at block 208 is yes, the process 200 continues to block 210. At block 210, the process 200 includes the electronic user device evaluating whether one or more rate criteria are satisfied. The one or more rate criteria may attempt to limit the total number of location collections within some given time period. Doing so may function to conserve battery life, processing, and network resources. For example, the one or more rate criteria may include a threshold of collections within an hour (e.g., 5 collections, 10 collections, 12 collections, 15 collections, or any other suitable number) and a threshold of collections within a day (e.g., 10 collections, 15 collections, 30 collections, 50 collections, or any other suitable number). In a particular example, if the number of collections in the last hour is less than 12 and the number of total collections in the last 24 hours is less than 30, the answer at block 210 may be yes. If one or more of these criteria is not satisfied, the answer at block 210 may be no, meaning the electronic user device will refrain from collecting location information.

If the answer at block 210 is yes, the process 200 continues to block 212. At block 212, the process 200 includes the electronic user device evaluating whether one or more distance criteria are satisfied. The one or more distance criteria may determine whether the current location of the electronic user device is within some threshold distance from one or more points of interest (e.g., a location where the techniques described herein may share location information of the electronic user device). For example, the electronic user device may determine whether the electronic user device is within a threshold distance from a point of interest (e.g., 50 meters, 100 meters, 200 meters, 500 meters, and any other suitable distance). If the answer is no, the process 200 may refrain from collecting location information, at block 206.

If the answer at block 212 is yes (e.g., the electronic user device is within 100 meters of a point of interest), the process 200 continues to block 214. At block 214, the process 200 obtains device location of the electronic user device. This may include using an onboard location device such as a GPS chip or other device to record the current location. In some examples, obtaining the device location may include using network triangulation or other known methods for determining device location. A device location may be stored in a data structure that includes, for example, a timestamp of collection, a latitude and longitude, a horizontal accuracy of the location, a vertical accuracy of the location, an altitude of the location, and any other suitable information. In some examples, the device location information may be combined with other information (e.g., a sub-region identifier for a sub-region in a location index) at later blocks and shared with the service provider.

The process 200 continues to FIG. 3, as shown by continuation block A. Blocks 202-214 shown in FIG. 2 may relate to whether or not the electronic user device should record a device location. Blocks 216-238 shown in FIG. 3 may relate to managing a location index, comparing current device location with a location index, and other related operations. Thus, continuing with the portion of the process 200 shown in FIG. 3, the process 200 includes, at block 216, the electronic user device evaluating whether one or more first location criteria are satisfied. This may include determining whether the device location collected at block 214 is suitable for purposes of these techniques. For example, the location criteria may consider an age of the current location information (e.g., is the age less than 5 minutes old, 10 minutes old, 15 minutes old, 20 minutes old, 30 minutes old, and/or any other suitable age), whether the electronic user device has moved since the last collection (e.g., is the current location within 5, 10, 15, 25, 50 meters of an instantaneous location or within any other suitable distance), an accuracy of the current location (e.g., does the current location have an associated accuracy that is less than or equal to 80 meters), and any other suitable criteria. If the answer at block 216 is no, the process 200 continues to block 206 and refrains from collecting location information.

If the answer at block 216 is yes, the process 200 continues to block 218. At block 218, the process 200 includes the electronic user device determining whether location index is present on the electronic user device. As a threshold, this may include checking whether any location index is present on the electronic user device and, if so, checking whether the location index is appropriate for the current location. For example, the electronic user device may compare the current location to confirm that the current location falls within a boundary of the geographic region associated with the location index. The check at 218 may be helpful when the user is traveling with their electronic user device, as this may result in the user arriving at a location for which the electronic user device has not already obtained the relevant location index.

If the answer at block 218 is no, the process 200 continues to block 220. At block 220, the electronic user device may flag the location index identifier associated with the current location to download. In some examples, this may essentially queue up downloading of the appropriate location index for the current location. In some examples, the electronic user device may also download the location index at this point. In other examples, the electronic user device may wait to download when certain criteria are met (e.g., when the electronic user device is connected to power and connected to a Wi-Fi network). In some examples, block 220 may include the electronic user device requesting the location index from a location index service provided by the service provider. In some examples, the location index service may provide a smaller or more narrowly defined indices as compared to a bulk download.

If the answer at block 218 is yes, the process 200 continues to block 222. At block 222, the process 200 includes the electronic user device determining whether one or more second location criteria are satisfied. This may include checking the location index to determine whether the location index indicates that the current location is within a sub-region marked for sharing. In particular, this may include the electronic user device comparing the current location with the location index to see if the current location should be reported to the service provider. In practice this may include determining whether the current location is within a sub-region of the location index that permits uploading (e.g., is associated with a location for which the service provider is collecting busyness information, etc.). The one or more second location criteria may include the current location not being within a radius of a private location, the private location not being within a prohibited region, and the current location being within a sub-region flagged for reporting.

At block 224, the process 200 includes the electronic user device saving the location-based payload on disk cache on the device (e.g., the electronic user device). This may include saving the association between the current location and the sub-region information identified at block 222. This information may be stored on the disk cache on the electronic user device before being shared with the service provider.

At block 226, the process 200 includes the electronic user device determining whether one or more upload criteria are satisfied. This may include evaluating whether the electronic user device is connected to a network (e.g., cellular, Wi-Fi, etc.) and within a predefined timeout period (e.g., 15 minutes). For example, if the electronic user device is connected to a network and within a 15-minute timeout period, the process 200 may proceed to block 228. At block 228, the process 200 includes the electronic user device uploading the location-based payload to the server (e.g., service provider). In particular, the electronic user device may access the location-based payload from the disk cache and send it to the service provider via the network connection.

If the answer at block 226 is no (e.g., the electronic user device is not connected to a network and/or is not within the 15-minute timeout period), the process 200 proceeds to block 230. At block 230, the process 200 includes the electronic user device returning to check the upload criteria again at 226.

The process 200 also includes the electronic user device pruning the disk cache at 232. This may be performed after the location information has been uploaded to the service provider, after a predetermined amount of time, to maintain a cache size below some limit, and/or in any other suitable manner.

At block 234, the process 200 may include the electronic user device evaluating whether one or more cache criteria are satisfied. This may include comparing the age of the cached data to a threshold (e.g., 12, hours, 15, hours, 18 hours, 24 hours, etc.). For example, if the cached data is older than 18 hours, the process 200 may return to block 230. If the cached at is not older than 18 hours, the process 200 may continue to block 236. At block 236, the process 200 includes the electronic user device deleting the cached data. The cached data will also be deleted if the electronic user device detects that the user has turned off location services, at block 238.

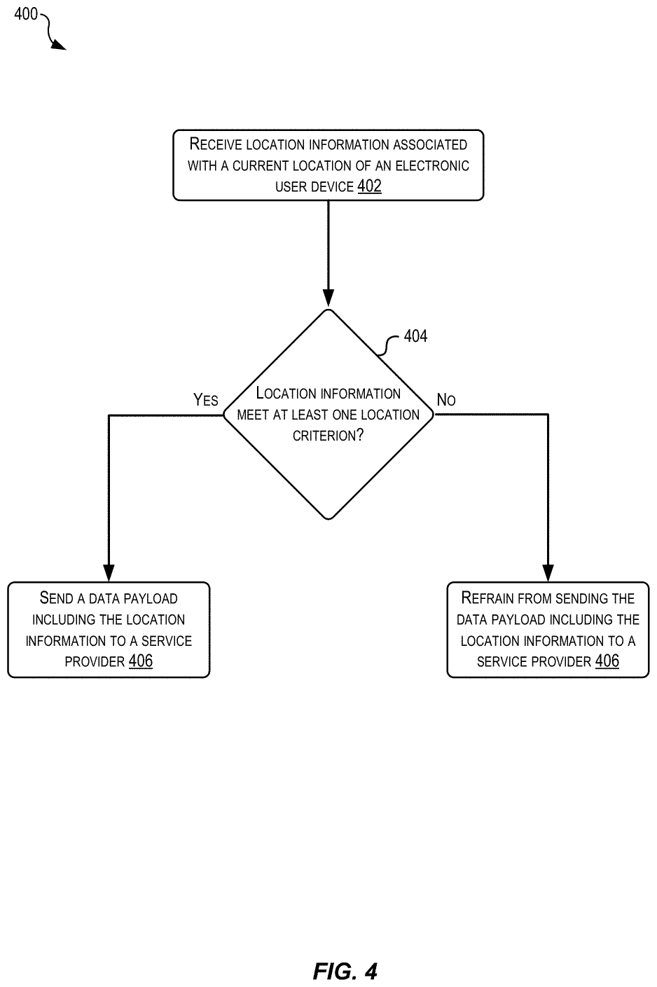

FIG. 4 illustrates a flow diagram illustrating an example process 400 for selective sharing of device location information, according to at least one example. A sharing application 610 (FIG. 6), whether embodied in an electronic user device 606 (FIG. 6) or a service provider computer 604 (FIG. 6), or any suitable combination of the foregoing may perform the process 400. Thus, while the process 400 is described as being performed by the electronic user device, it should be understood that other user devices (e.g., a wearable user device) or a server may perform the process 400 with limited adjustments.

The process 400 begins at block 402 by an electronic user device (e.g., a user device 102 or 606 described elsewhere herein) receiving location information associated with a current location of the electronic user device. The current location may be determined by the electronic user device using any suitable technique (e.g., network triangulation, GPS signals, Wi-Fi, etc.).

At block 404, the process 400 includes the electronic user device determining whether the location information meets at least one criterion. In some examples, the at least one criterion may be one of a plurality of criterion. A first criterion of the plurality of criteria may include determining whether a location index includes a sub-region identifier for a sub-region that includes the current location. The location index, as described herein may represent a particular geographic region and may be useable by the electronic user device to determine whether to share location information. In some examples, the location sharing may be limited to sharing location when certain events occur on electronic user device (e.g., application launch events). In some examples, the at least one criterion is the first criterion. In this example, other location criteria may not be considered. The electronic user device may receive the location index from the service provider.

In some examples, block 404 may also include considering a second criterion of the plurality of criteria. The second criterion may include determining whether an age of the current location is less than or equal to a location age threshold. For example, to avoid sharing stale location information, this criterion may ensure that the age of the location information is less than or equal to the location age threshold.

In some examples, block 404 may also include considering a third criterion of the plurality of criteria. The third criterion may include a location accuracy value for the location information is less than or equal to location accuracy threshold. This may ensure that the location information is accurate in at least one dimension (e.g., horizontal, vertical, and/or both).

In some examples, block 404 may also include considering a fourth criterion of the plurality of criteria. The fourth criterion may include determining that the location information was received less than or equal to a location sent threshold. This may ensure that the location information was captured within some predefined time prior to the current time.

In some examples, block 404 may also include considering a fifth criterion of the plurality of criteria. The fifth criterion may determine that location information captured is within some predefined distance from an updated location of the electronic user device at the time of sending.

The location index may include sub-region identifiers for those sub-regions that includes points of interest and not include sub-region identifiers for those sub-regions where location sharing is undesirable for privacy purposes. As such, the decision at block 402 may represent that the current location is within a sub-region that includes a point of interest and therefore is not an excluded region and should be shared. Thus, if the answer at 402 is “yes,” the process 400 proceeds to 406. In some examples, the sub-region identifier represents that the sub-region includes at least one point of interest.

At block 46, the process 400 includes the electronic user device sending a data payload including the location information to a service provider when the at least one criterion is met.

If the answer at 404 is no, the process 400 proceeds to block 408. At block 408, the process 400 includes the electronic user device refraining from sending the data payload including the location information to the service provider when the at least one criterion is not met.

In some examples, the process 400 may further include receiving the location index from the service provider, which may include receiving the location index when at least one power criterion is met, the at least one power criterion comprising at least one of the electronic user device in a charging state or the electronic user device connected to a network.

In some examples, the process 400 may further include, prior to determining whether the location information meets the at least one criterion, determining that at least one upload criterion is met, the at least one upload criterion comprising at least one of a power mode criterion, a battery charge strength criterion, or non-public user criterion.

In some examples, the location index may represent a geographic region that includes a plurality of sub-regions, at least some sub-regions of the plurality of sub-regions being identified by sub-region identifiers. The location index may be specific to the geographic region. In some examples, each sub-region that may be identified by a corresponding sub-region identifier that comprises at least one point of interest or area of interest. In some examples, the geographic region may include a rectangular perimeter and a plurality of equally-size sub-regions that correspond to the plurality of sub-regions.

In some examples, the location information may include latitude and longitude coordinates. In some examples, the data payload may further include horizontal accuracy of the location information, vertical accuracy of the location information, altitude, and a timestamp.

In some examples, the geographic region may be divided into any suitable division such as a city, county, metropolitan area, predefined shape, and/or any suitable combination of the foregoing, which may include predefined based on square kilometers, etc.

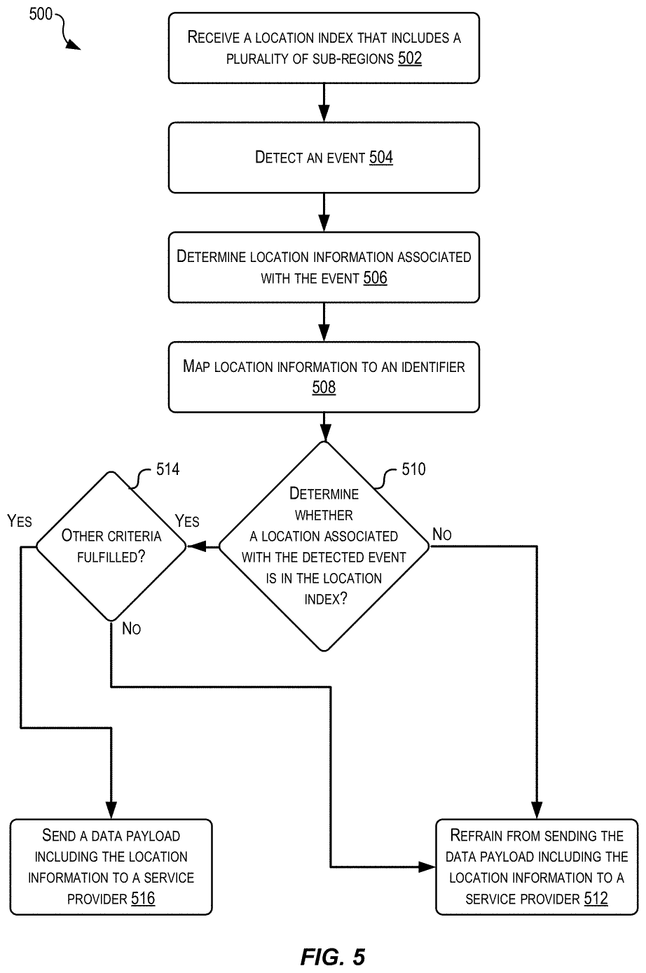

FIG. 5 illustrates a flow diagram illustrating an example process 500 for selective sharing of device location information, according to at least one example. A sharing application 610 (FIG. 6), whether embodied in an electronic user device 606 (FIG. 6) or a service provider computer 604 (FIG. 6), or any suitable combination of the foregoing may perform the process 500. Thus, while the process 500 is described as being performed by the electronic user device, it should be understood that other user devices (e.g., a wearable user device) or a server may perform the process 500 with limited adjustments.

The process 500 begins at block 502 by the electronic user device receiving a location index that includes a plurality of sub-regions. The location index may be received from a service provider. The location index may be specific to a particular region and may identify, for the particular region, a plurality of sub-regions. In some examples, first sub-regions of the plurality of sub-regions are identified in the location index using tile identifiers (e.g., sub-region identifiers).

At block 504, the process 500 includes the electronic user device detecting an event. In some implementations, the event may be associated with launching an application on the electronic user device. In other implementations, the event may be detected activity from a sensor, camera, or other device.

At block 506, the process 500 includes the electronic user device determining location information associated with the event. This location may be represented as latitude and longitude coordinates. In some examples, the electronic user device may filter the location index if the location is near a private location (e.g., home, work, etc.). The electronic user device alone may maintain information about these locations. Because the service provider does not receive and/or maintain information about private locations, the location index does not identify private locations. Rather, the electronic user device will compare the location with the locally stored private locations as part of performing the techniques described herein. In some examples, this may include filtering the location index in a manner that eliminates the possibility of the device sending and/or sharing location information associated with events that occur near these private locations. In some examples, an event may be considered to have occurred near a private location when a location associated with the event is within some threshold distance from the private location (e.g., within a 10 meter, 20 meter, 50 meter, 100 meter, etc. radius surrounding the private location), within a boundary defined around the private location, and/or in any other suitable manner.

At block 508, the process 500 includes the electronic user device mapping location information to an identifier, e.g., a tile identifier. This mapping may include the electronic user device querying an on-device database or other database. In some implementations, the identifier is determined based on latitude, longitude, and zoom level of the location information.

At block 510, the process 500 includes the electronic user device determining whether a location associated with the detected event (represented by the location information) is in the location index. For example, this determination may include querying the on-device database (e.g., Key Value store) to check if the location index includes the identifier (e.g., tile identifier) from block 508. The tile identifier may correspond to a key in the key value store. For those locations (identified by tile identifiers) that are approved for sharing, the key value store may include a value using each tile identifier as a key. For those locations that are not approved for sharing, the key value store may not include values for the tile identifiers corresponding to the locations. If the key exists in the Key Value store (e.g., that stores the location index), the location information associated with the event may be shared with the service provider, as described below. In some examples, the electronic user device may log the location information in connection with block 510 for a later upload (e.g., as part of a periodic upload, bulk upload, or the like).

If the answer at 510 is no, the process 500 proceeds to block 512, at which, the process 500 includes the electronic user device refraining from sending the data payload including the location information to the service provider when the sub-region identifier is not in the location index (e.g., when sub-region identifier is not one of the first sub-regions).

If the answer at 510 is yes, the process 500 proceeds to block 514, at which, the process 500 includes the electronic user device determining whether other criteria are fulfilled. If no, the process refrains from sending the data at 512. If yes, the process 500 includes the electronic user device sending a data payload including the location information to the service provider.

In some examples, the location information may be associated with a timestamp and a current location of the electronic user device. In this example, the process 500 may further include a threshold comparison at block 514 including least one of: determining that an age of the current location is less than an age threshold based at least in part on the timestamp, determining that a location accuracy value for the location information is less than a location accuracy threshold, and/or determining that the location information is was received less than or equal to a location sent threshold.

In some examples, sending the data payload including the location information to the service provider may include sending the data payload including the location information to the service provider based at least in part on the threshold comparison (e.g., block 514 to block 516). In some examples, refraining from sending the data payload including the location information to the service provider further includes refraining from sending the data payload including the location information to the service provider based at least in part on the threshold comparison (e.g., block 516 to block 512).

In some examples, the process 500 may further include prior to receiving the location index, at block 502, determining a current location of the electronic user device, and requesting the location index based at least in part on the current location of the electronic user device. In some examples, the process 500 may further include determining an updated location of the electronic user device, and requesting an updated location index based at least in part on the updated location.

In some examples, the location information may identify a current location of the electronic user device when the application launch event was detected. In some examples, the particular region may include a rectangular boundary with a grid area. In some examples, the grid area may include a plurality of cells, with each cell representing a sub-region of the plurality of sub-regions.

In some examples, each of the first sub-regions of the plurality of sub-regions may be associated with a point of interest or an area of interest. In some examples, at least one of the point of interest or the area of interest correspond to a commercial establishment.

In some examples, second sub-regions of the plurality of sub-regions are not identified in the location index using the sub-region identifiers (e.g., tile identifiers). In some examples, the second sub-regions include non-public locations. In some examples, determining whether the location associated with the detected event in the location index may include determining whether a sub-region identifier exists in the location index for the determined first sub-region. In some examples, sharing the data payload including the location information with the service provider at block 516 may include sharing the data payload comprising the location information with the service provider when the sub-region identifier exists in the location index for the determined first sub-region.

In some examples, refraining from sharing the location information with the service provider at block 512 may include refraining from sharing the location with the service provider when the sub-region identifier does not exist in the location index for the determined first sub-region.

FIG. 6 illustrates an example architecture or environment 600 configured to implement techniques described herein, according to at least one example. In some examples, the example architecture 600 may further be configured to enable a user device 606 (e.g., electronic user device 102 described herein) and service provider computer 604 (e.g., the service provider computer 104 described herein) to share information. In some examples, the devices may be connected via one or more networks 608 (e.g., via Bluetooth, Wi-Fi, the Internet). In some examples, the service provider computer 604 may be configured to implement at least some of the techniques described herein with reference to the electronic user device 606 and vice versa.

In some examples, the networks 608 may include any one or a combination of many different types of networks, such as cable networks, the Internet, wireless networks, cellular networks, satellite networks, other private and/or public networks, or any combination thereof. While the illustrated example represents the electronic user device 606 accessing the service provider computer 604 via the networks 608, the described techniques may equally apply in instances where the electronic user device 606 interacts with the service provider computer 604 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the electronic user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the electronic user device 606 may be in communication with the service provider computer 604 via the network 608, or via other network connections.

In one illustrative configuration, the electronic user device 606 may include at least one memory 614 and one or more processing units (or processor(s)) 616. The processor(s) 616 may be implemented as appropriate in hardware, computer-executable instructions, firmware, or combinations thereof. Computer-executable instruction or firmware implementations of the processor(s) 616 may include computer-executable or machine-executable instructions written in any suitable programming language to perform the various functions described. The electronic user device 606 may also include geo-location devices 632 (e.g., a global positioning system (GPS) device or the like) for providing and/or recording geographic location information associated with the electronic user device 606.

The memory 614 may store program instructions that are loadable and executable on the processor(s) 616, as well as data generated during the execution of these programs. Depending on the configuration and type of the electronic user device 606, the memory 614 may be volatile (such as random access memory (RAM)) and/or non-volatile (such as read-only memory (ROM), flash memory, etc.). The electronic user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 614 and the additional storage 626 are both examples of non-transitory computer-storage media. Additional types of computer-storage media that may be present in the electronic user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the electronic user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The electronic user device 606 may also contain communications connection(s) 628 that allow the electronic user device 606 to communicate with a data store, another computing device or server, user terminals, and/or other devices via the network 608. The electronic user device 606 may also include I/O device(s) 630, such as a keyboard, a mouse, a pen, a voice input device, a touch screen input device, a display, speakers, a printer, etc.

Turning to the contents of the memory 614 in more detail, the memory 614 may include an operating system 612 and/or one or more application programs or services for implementing the features disclosed herein such as applications 610 (e.g., health application, a maps application, digital wallet, third-party applications, browser application). In some examples, the applications 610 may include a specialized application, applet, firmware, or the like to perform similar techniques as described with reference to the processes 200, 400, and 500. Similarly, at least some techniques described with reference to the service provider computer 604 may be performed by the electronic user device 606.

The service provider computer 604 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 604 may be in communication with the electronic user device 606 via the network 608, or via other network connections.

In one illustrative configuration, the service provider computer 604 may include at least one memory 642 and one or more processing units (or processor(s)) 644. The processor(s) 644 may be implemented as appropriate in hardware, computer-executable instructions, firmware, or combinations thereof. Computer-executable instruction or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs.

Depending on the configuration and type of service provider computer 604, the memory 642 may be volatile (such as RAM) and/or non-volatile (such as ROM, flash memory, etc.). The service provider computer 604 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional removable storage 646, both removable and non-removable, are both additional examples of non-transitory computer-readable storage media.

The service provider computer 604 may also contain communications connection(s) 648 that allow the service provider computer 604 to communicate with a data store, another computing device or server, user terminals, and/or other devices via the network 608. The service provider computer 604 may also include I/O device(s) 650, such as a keyboard, a mouse, a pen, a voice input device, a touch input device, a display, speakers, a printer, etc.

Turning to the contents of the memory 642 in more detail, the memory 642 may include an operating system 652 and/or one or more application programs 610 or services for implementing the features disclosed herein.

In the following, further examples are described to facilitate the understanding of the present disclosure.

### Example 1

In this example, there is provided a computer-implemented method implemented at an electronic user device, the method comprising:
receiving location information associated with a current location of the electronic user device;
determining whether the location information meets at least one criterion of a plurality of criteria, wherein a first criterion of the plurality of criteria includes whether a location index includes a sub-region identifier for a sub-region that includes the current location;
sending a data payload comprising the location information to a service provider when the at least one criterion is met; and
refraining from sending the data payload comprising the location information to the service provider when the at least one criterion is not met.

In this example, there is provided a computer-implemented method of any of the preceding or subsequent examples, wherein the at least one criterion is the first criterion.

In this example, there is provided a computer-implemented method of any of the preceding or subsequent examples, wherein the sub-region identifier represents that the sub-region includes a point of interest.

In this example, there is provided a computer-implemented method of any of the preceding or subsequent examples, wherein a second criterion of the plurality of criteria includes whether an age of the current location is less than or equal to a location age threshold.

In this example, there is provided a computer-implemented method of any of the preceding or subsequent examples, wherein a second criterion of the plurality of criteria includes a location accuracy value for the location information is less than or equal to location accuracy threshold.

In this example, there is provided a computer-implemented method of any of the preceding or subsequent examples, wherein a second criterion of the plurality of criteria includes determining that the location information was received less than or equal to a location sent threshold.

In this example, there is provided a computer-implemented method of any of the preceding or subsequent examples, wherein a second criterion of the plurality of criteria includes determining that the current location is greater than or equal to a location distance threshold.

In this example, there is provided a computer-implemented method of any of the preceding or subsequent examples, further comprising receiving the location index from the service provider.

In this example, there is provided a computer-implemented method of any of the preceding or subsequent examples, wherein receiving the location index from the service provider includes receiving the location index when at least one power condition is met, the at least one power condition comprising at least one of the electronic user device in a charging state or the electronic user device connected to a network.

In this example, there is provided a computer-implemented method of any of the preceding or subsequent examples, further comprising, prior to determining whether the location information meets the at least one criterion, determining that at least one upload condition is met, the at least one upload condition comprising at least one of a power mode condition, a battery charge strength condition, or non-public user location condition.

In this example, there is provided a computer-implemented method of any of the preceding or subsequent examples, wherein the location index represents a geographic region that includes a plurality of sub-regions, at least some sub-regions of the plurality of sub-regions being identified by sub-region identifiers.

In this example, there is provided a computer-implemented method of any of the preceding or subsequent examples, wherein the location index is specific to the geographic region.

In this example, there is provided a computer-implemented method of any of the preceding or subsequent examples, wherein each sub-region that is identified by a corresponding sub-region identifier includes at least one point of interest or area of interest.

In this example, there is provided a computer-implemented method of any of the preceding or subsequent examples, wherein the geographic region includes a rectangular perimeter and a plurality of equally-sized cells that correspond to the plurality of sub-regions.

In this example, there is provided a computer-implemented method of any of the preceding or subsequent examples, wherein the location information includes latitude and longitude coordinates.

In this example, there is provided a computer-implemented method of any of the preceding or subsequent examples, wherein the data payload further includes horizontal accuracy of the location information, vertical accuracy of the location information, altitude, and a timestamp.

In this example, there is provided an apparatus, comprising:
a memory comprising computer-executable instructions; and
one or more processors in communication with the memory and configured to access the memory and execute the computer-executable instructions to perform the method of any of the preceding examples.

In this example, there is provided one or more computer-readable storage devices comprising computer-executable instructions that, when executed by one or more processors, cause the one or more processors to perform the method of any of the preceding examples.

In this example, there is provided a computer-implemented method, comprising:
receiving, by an electronic user device and from a service provider, a location index that is specific to a particular region and identifies, for the particular region, a plurality of sub-regions, wherein first sub-regions of the plurality of sub-regions are identified in the location index using sub-region identifiers;
detecting an event associated the electronic user device;
determining location information associated with the event;
determining a first sub-region associated with the event based at least in part on the location information and the location index;
determining whether the determined first sub-region is one of the first sub-regions based at least in part on the location index;
sending a data payload comprising the location information to the service provider when the sub-region is one of the first sub-regions; and
refraining from sending the data payload comprising the location information to the service provider when the sub-region identifier is not one of the first sub-regions.

In this example, there is provided a computer-implemented method of any of the preceding or subsequent examples, wherein the event includes an application launch event.

In this example, there is provided a computer-implemented method of any of the preceding or subsequent examples, wherein determining the first sub-region associated with the event based at least in part on the location information and the location index includes mapping the location information to a sub-region identifier in the location index.

In this example, there is provided a computer-implemented method of any of the preceding or subsequent examples, wherein determining whether the determined first sub-region is one of the first sub-regions includes determining whether the current location associated with the location information is in the location index.

In this example, there is provided a computer-implemented method of any of the preceding or subsequent examples, wherein the location information is associated with a timestamp and a current location of the electronic user device, and wherein the method further includes performing a threshold comparison comprising at least one of:
determining that an age of the current location is less than an age threshold based at least in part on the timestamp;
determining that a location accuracy value for the location information is less a location accuracy threshold; or
determining that the location information is was received less than or equal to a location sent threshold.

In this example, there is provided a computer-implemented method of any of the preceding or subsequent examples, wherein sending the data payload comprising the location information to the service provider includes sending the data payload comprising the location information to the service provider based at least in part on the threshold comparison.

In this example, there is provided a computer-implemented method of any of the preceding or subsequent examples, wherein refraining from sending the data payload comprising the location information to the service provider further includes refraining from sending the data payload comprising the location information to the service provider based at least in part on the threshold comparison.

In this example, there is provided a computer-implemented method of any of the preceding or subsequent examples, further comprising, prior to receiving the location index:
determining a current location of the electronic user device; and
requesting the location index based at least in part on the current location of the electronic user device.

In this example, there is provided a computer-implemented method of any of the preceding or subsequent examples, further comprising:
determining an updated location of the electronic user device; and
requesting an updated location index based at least in part on the updated location.

In this example, there is provided a computer-implemented method of any of the preceding or subsequent examples, wherein the location information identifies a current location of the electronic user device when the event was detected.

In this example, there is provided a computer-implemented method of any of the preceding or subsequent examples, wherein the particular region includes a rectangular boundary with a grid area.

In this example, there is provided a computer-implemented method of any of the preceding or subsequent examples, wherein the grid area includes a plurality of cells, with each cell representing a sub-region of the plurality of sub-regions.

In this example, there is provided a computer-implemented method of any of the preceding or subsequent examples, wherein each of the first sub-regions of the plurality of sub-regions is associated with a point of interest or an area of interest.

In this example, there is provided a computer-implemented method of any of the preceding or subsequent examples, wherein at least one of the point of interest or the area of interest corresponds to a commercial establishment.

In this example, there is provided a computer-implemented method of any of the preceding or subsequent examples, wherein second sub-regions of the plurality of sub-regions are not identified in the location index using the sub-region identifiers.

In this example, there is provided a computer-implemented method of any of the preceding or subsequent examples, wherein the second sub-regions include non-public locations, at least one of which is associated with a user profile of the electronic user device.

In this example, there is provided a computer-implemented method of any of the preceding or subsequent examples, wherein determining whether the determined first sub-region is one of the first sub-regions includes determining whether a sub-region identifier exists in the location index for the determined first sub-region.

In this example, there is provided a computer-implemented method of any of the preceding or subsequent examples, wherein sharing the data payload comprising the location information with the service provider includes sharing the data payload comprising the location information with the service provider when the sub-region identifier exists in the location index for the determined first sub-region.

In this example, there is provided a computer-implemented method of any of the preceding or subsequent examples, wherein refraining from sharing the location information with the service provider includes refraining from sharing the location information with the service provider when the sub-region identifier does not exist in the location index for the determined first sub-region.

In this example, there is provided an apparatus, comprising:
a memory comprising computer-executable instructions; and
one or more processors in communication with the memory and configured to access the memory and execute the computer-executable instructions to perform the method of any of the preceding examples.

In this example, there is provided one or more computer-readable storage devices comprising computer-executable instructions that, when executed by one or more processors, cause the one or more processors to perform the method of any of the preceding examples.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is sending selective location information to a service provider. This does not include sharing of personally identifiable information (PII) data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's geolocation based experiences such as busyness features for restaurants. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the receipt, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the receipt and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method implemented at an electronic user device, the method comprising:
receiving location information associated with a current location of the electronic user device;
determining whether the location information meets at least one criterion of a plurality of location criteria, wherein a first criterion of the plurality of location criteria comprises whether a location index includes a sub-region identifier for a sub-region that includes the current location;
sending a data payload comprising the location information to a service provider when the at least one criterion is met; and
refraining from sending the data payload comprising the location information to the service provider when the at least one criterion is not met.

2. The computer-implemented method of claim 1, wherein the at least one criterion is the first criterion.

3. The computer-implemented method of claim 1, wherein the sub-region identifier represents that the sub-region includes a point of interest.

4. The computer-implemented method of claim 1, wherein a second criterion of the plurality of location criteria comprises whether an age of the current location is less than or equal to a location age threshold.

5. The computer-implemented method of claim 1, wherein a second criterion of the plurality of location criteria comprises a location accuracy value for the location information is less than or equal to location accuracy threshold.

6. The computer-implemented method of claim 1, wherein a second criterion of the plurality of criteria comprises determining that the location information was received less than or equal to a location sent threshold.

7. The computer-implemented method of claim 1, wherein a second criterion of the plurality of criteria comprises determining that the current location is greater than or equal to a location distance threshold.

8. One or more computer-readable storage devices comprising computer-executable instructions that, when executed by one or more processors, cause the one or more processors to perform operations comprising:
receiving location information associated with a current location of an electronic user device;
determining whether the location information meets at least one criterion of a plurality of location criteria, wherein a first criterion of the plurality of location criteria comprises whether a location index includes a sub-region identifier for a sub-region that includes the current location;
sending a data payload comprising the location information to a service provider when the at least one criterion is met; and
refraining from sending the data payload comprising the location information to the service provider when the at least one criterion is not met.

9. The one or more computer-readable storage devices of claim 8, wherein the one or more computer-readable storage devices comprise additional instructions that, when executed by the one or more processors, cause the one or more processors to perform additional operations comprising receiving the location index from the service provider.

10. The one or more computer-readable storage devices of claim 8, wherein receiving the location index from the service provider comprises receiving the location index when at least one power criterion is met, the at least one power criterion comprising at least one of the electronic user device in a charging state or the electronic user device connected to a network.

11. The one or more computer-readable storage devices of claim 8, wherein the one or more computer-readable storage devices comprise additional instructions that, when executed by the one or more processors, cause the one or more processors to perform additional operations comprising, prior to determining whether the location information meets the at least one criterion, determining that at least one upload criterion is met, the at least one upload criterion comprising at least one of a power mode criterion, a battery charge strength criterion, or non-public user location criterion.

12. The one or more computer-readable storage devices of claim 8, wherein the location index represents a geographic region that includes a plurality of sub-regions, at least some sub-regions of the plurality of sub-regions being identified by sub-region identifiers.

13. The one or more computer-readable storage devices of claim 12, wherein the location index is specific to the geographic region.

14. The one or more computer-readable storage devices of claim 12, wherein each sub-region that is identified by a corresponding sub-region identifier comprises at least one point of interest or area of interest.

15. The one or more computer-readable storage devices of claim 12, wherein the geographic region comprises a rectangular perimeter and a plurality of equally-sized cells that correspond to the plurality of sub-regions.

16. An apparatus, comprising:
a memory comprising computer-executable instructions; and
one or more processors in communication with the memory and configured to access the memory and execute the computer-executable instructions to at least:
receive location information associated with a current location of the apparatus;
determine whether the location information meets at least one criterion of a plurality of location criteria, wherein a first criterion of the plurality of location criteria comprises whether a location index includes a sub-region identifier for a sub-region that includes the current location;
send a data payload comprising the location information to a service provider when the at least one criterion is met; and
refrain from sending the data payload comprising the location information to the service provider when the at least one criterion is not met.

17. The apparatus of claim 16, wherein the location information comprises latitude and longitude coordinates.

18. The apparatus of claim 16, wherein the data payload further comprises horizontal accuracy of the location information, vertical accuracy of the location information, altitude, and a timestamp.

19. The apparatus of claim 16, wherein the sub-region identifier represents that the sub-region includes a point of interest.

20. The apparatus of claim 16, wherein the location index represents a geographic region that includes a plurality of sub-regions, at least some sub-regions of the plurality of sub-regions being identified by sub-region identifiers.
